(19) United States
(12) Patent Application Publication
(10) Pub. No.: US 2016/0052649 A1
(43) Pub. Date: Feb. 25, 2016

(54) FAIL-SAFE COMMAND DESTRUCT SYSTEM

(71) Applicant: Ventions, LLC, San Francisco, CA (US)

(72) Inventor: Adam P. London, San Francisco, CA (US)

(21) Appl. No.: 14/824,578

(22) Filed: Aug. 12, 2015

Related U.S. Application Data
(60) Provisional application No. 62/040,248, filed on Aug. 21, 2014.

(51) Int. Cl. B64G 1/24; B64G 1/52; B64G 1/00

(52) U.S. Cl. CPC B64G 1/24; B64G 1/002; B64G 1/52

(57) ABSTRACT

A fail safe command destruct system for a multi-stage rocket comprising a first stage flight termination system and an upper stage command enable system. The flight termination system has the added feature that the same battery is the sole power source to the flight termination receiver and to a normally off flight inhibitor that requires power to permit engine operation. The command enable system has a normally inhibiting flight inhibitor that requires power to permit engine operation. The same battery is the sole source of power to the command enable receiver and the flight inhibitor such that battery failure prevents engine ignition. Lack of a command from outside the rocket to the command enable receiver also prevents engine ignition.

### CROSS REFERENCE TO RELATED APPLICATIONS

This application claims the benefit of U.S. provisional patent application Ser. No. 62/040,248 filed Aug. 21, 2014 to the same inventor.

### STATEMENT REGARDING FEDERALLY SPONSORED RESEARCH AND DEVELOPMENT

This invention was made with government support under contract FA8650-12-C-7274 awarded by the US Air Force. The government has certain rights in the invention. The research in this document was developed with funding from the Defense Advanced Research Projects Agency (DARPA). Distribution Statement A: Approved for Public Release, Distribution Unlimited.

### FIELD OF ART

The present invention relates to a fail-safe flight termination system (FTS) for multi-stage launch vehicles. The present invention also relates to an FTS that uses a common FTS receiver battery to open normally closed fuel valves. The present invention also relates to use of inhibits to render the upper stage of a multi-stage launch vehicle non-propulsive until a ground-based command is sent to activate the propulsion system after the upper stage reaches a safe point in the trajectory.

### SUMMARY OF THE INVENTION

Briefly described the invention includes methods for making safe stages on launch vehicles (rockets). In one embodiment for liquid-fueled stages, a normally closed valve is kept open by power from a common flight termination receiver battery, such that failure of the flight termination receiver battery closes the fuel valve to the engine, shutting down the engine in a fail-safe mode. In a second embodiment for a liquid-fueled or solid rocket that is deemed not to require an FTS on the upper stage, a command, wirelessly sent from the ground, must be received to remove ignition inhibits, thereby rendering the upper stage propulsive only after it has reached a safe point in the trajectory.

### DESCRIPTION OF THE FIGURES OF THE DRAWINGS

The present invention will hereinafter be described in conjunction with the following drawing figures, wherein like numerals denote like elements, and

FIG. 1A is a perspective view illustrating an exemplary embodiment of the fail-safe command destruct system in a successful launch, according to a preferred embodiment of the present invention;

FIG. 1B is a perspective view illustrating an exemplary embodiment of the fail-safe command destruct system of FIG. 1A in an unsuccessful launch, according to a preferred embodiment of the present invention;

FIG. 2 is a diagrammatic view illustrating an exemplary embodiment of the fail-safe command destruct system of FIG. 1A, according to a preferred embodiment of the present invention;

FIG. 3 is a block diagram illustrating an exemplary embodiment of the fail-safe command destruct system for the stages of a liquid-fueled rocket that are deemed to require an FTS, according to a preferred embodiment of the present invention;

FIG. 4 is a block diagram illustrating a second exemplary embodiment of the fail-safe command destruct system of FIG. 1A for a liquid-fueled stage, according to a preferred embodiment of the present invention;

FIG. 5 is a block diagram illustrating an exemplary embodiment of the fail-safe command destruct system for a solid-fueled stage, according to a preferred embodiment of the present invention; and

FIG. 6 is a block diagram illustrating a third exemplary embodiment of the fail-safe command destruct system of FIG. 1A for a liquid-fueled stage, according to a preferred embodiment of the present invention.

### DETAILED DESCRIPTION OF THE INVENTION

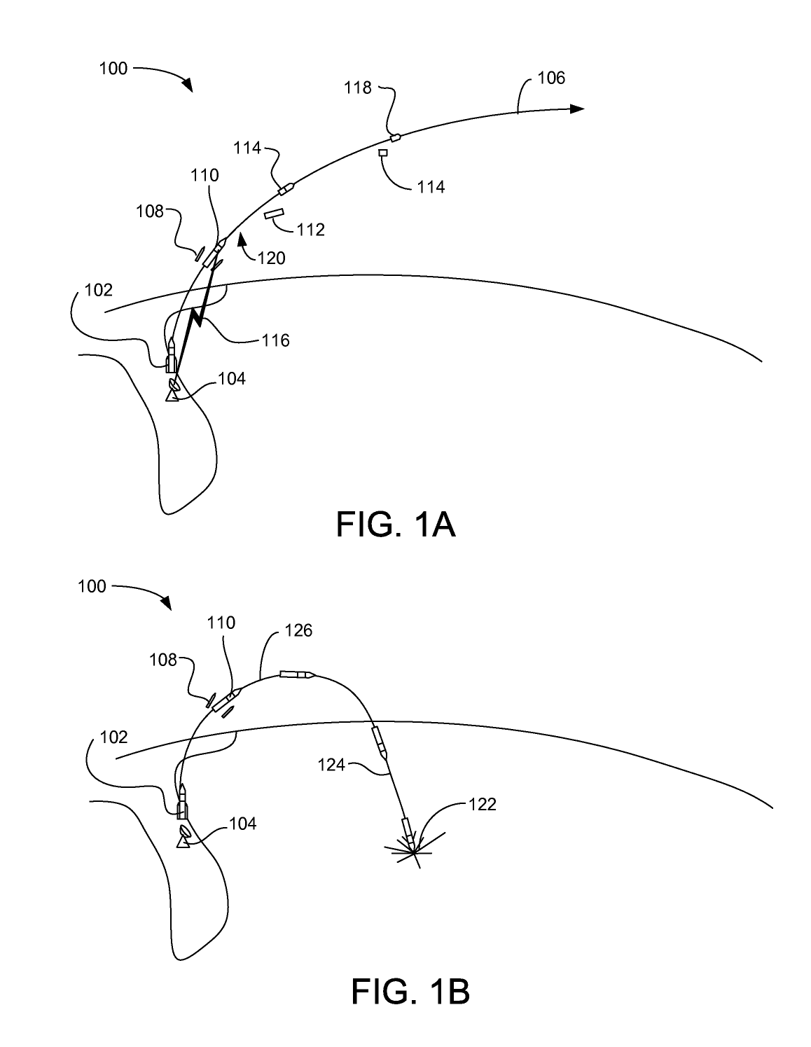

FIG. 1A is a perspective view illustrating an exemplary embodiment of the fail-safe command destruct system 100 in a successful launch, according to a preferred embodiment of the present invention. Multistage launch vehicle 102 with strap-on solid rocket motors 108 (one of two illustrated is labeled) launches from the planet surface along ascent-to-orbit trajectory 106. When the strap-on solid rocket motors have burned out, the strap-on solid rocket motors 108 separate from the main body 110 of the launch vehicle 102. In this example only, solid rocket motor separation is taken as the point at which the main body 110 is in a range-safe state where, if the launch vehicle 102 fails past this point, the debris will not affect those on the ground. In various other embodiments, the safety gate may be reached before or after separation of the solid rocket motors. A command is sent via ground station 104 via communications link 116 to remove ignition inhibits on the second stage 114 prior to separation of the first stage 112 at point 120. In a particular embodiment, the command can be sent from any source outside the rocket, such a ship, aircraft, or satellite.

The present invention is not limited to launch vehicles 102 with strap-on solid rocket motors 108 and, in various launch vehicle and payload configurations, the range-safe state may be reached independently of solid rocket motor separation on launch vehicles 102 that use strap-on rocket motors 108, whether solid or liquid fueled. Furthermore, the present invention is not limited to surface-launched launch vehicles 102, but may be used with air-launched multistage launch vehicles as well.

FIG. 1B is a perspective view illustrating an exemplary embodiment of the fail-safe command destruct system 100 of FIG. 1A in an unsuccessful launch, according to a preferred embodiment of the present invention. When the launch vehicle 102 is not in a range-safe state prior to second stage ignition, such as being on failed trajectory 126, the command enable signal is not sent via link 116, and so the second stage propulsion is always inhibited. The launch vehicle body 110 falls to Earth 122, possibly becoming a debris cloud at some point 124.

The command enable signal is sent via link 116 from the ground station 104 only if the launch vehicle 102 is in a range-safe state. The command enable signal may be generated automatically by a computer responsive to telemetry from the launch vehicle 102 and/or tracking data representing the launch vehicle trajectory 106. In other embodiments, human intervention may be required to generate the command enable signal. In some cases, the command may be sent from an airborne command facility or a shipboard command facility.

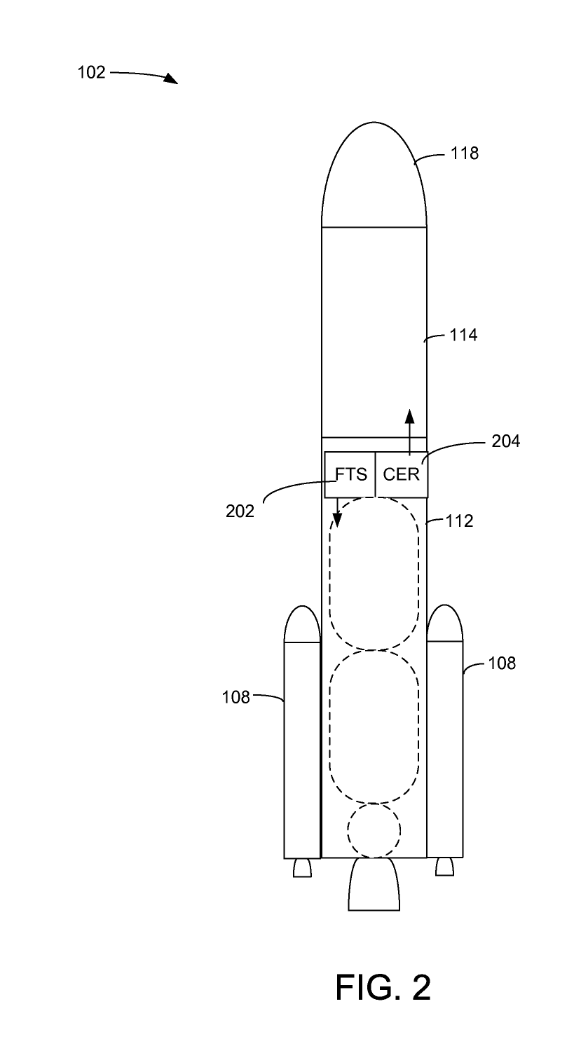

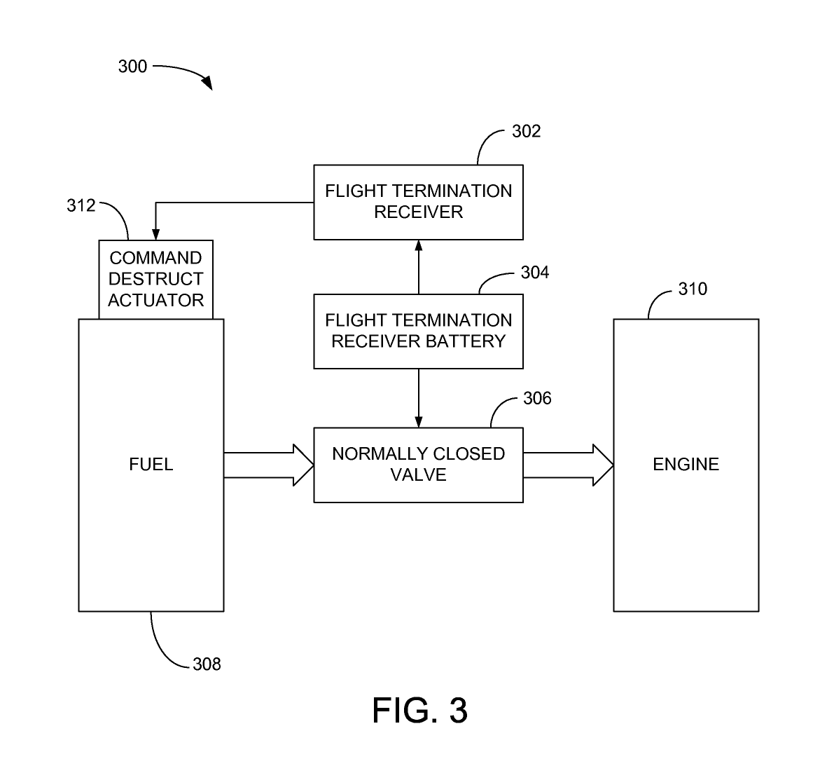

FIG. 2 is a diagrammatic view illustrating an exemplary embodiment of the fail-safe command destruct system of FIG. 1A, according to a preferred embodiment of the present invention. The FTS 202 is in the first stage 112 and can destroy the first stage responsive to a command from the ground. Second stage 114 does not have an FTS 202, as it would not normally fire until after first stage 112 has carried it past the range safety gate. First stage 112 has a command enable receiver (CER) 204, which must receive a signal from outside the rocket to remove ignition inhibits in the second stage 114. Any number of upper stages 114 may be coupled to the CER 204. The CER 204 may also be combined with the FTS receiver 302 (see FIG. 3) in a single piece of hardware.

FIG. 3 is a block diagram illustrating an exemplary embodiment of the fail-safe command destruct system 300 for the stages of liquid-fueled rocket that are deemed to require an FTS 202, according to a preferred embodiment of the present invention. FTS 202 includes the flight termination receiver 302, the flight termination receiver battery 304, and the command destruct actuator 312. Normally closed valve 306 is in the fuel line between the fuel tank 308 and the engine 310 and requires a supply of electrical power to hold valve 306 open to enable fuel to flow to the engine 310. Valve 306 is kept open by constant power from the flight termination receiver battery 304, which also powers the flight termination receiver 302. If the flight termination receiver battery 304 fails during launch, the first stage 112 cannot receive a command destruct signal in the flight termination receiver 302 and so cannot activate the command destruct actuator 312 to destroy the vehicle (exemplified as blowing up the fuel tank 308, but possible by various means known in the art). However, failure of the flight termination receiver battery 304 also causes valve 306 to close, cutting off the engine 310 and allowing the launch vehicle 102 to fall back to Earth 122. Those of skill in the art, illuminated by the present disclosure, will understand that a normally closed valve 306 may, alternatively or additionally, be used to control the flow of oxidizer (not shown) to engine 310. With the battery 304 operating correctly on an anomalous trajectory 126, it is a judgment call for the range safety officer whether to bring down the vehicle 102 by not enabling (or cutting off) fuel and/or oxidizer flow to the engine 310 or by using the command destruct actuator 312. The same common battery architecture may also be used in an autonomous flight safety system to simultaneously power the valves and the autonomous intelligence system on-board, such that any battery failure automatically shuts off the engines in a fail-safe mode.

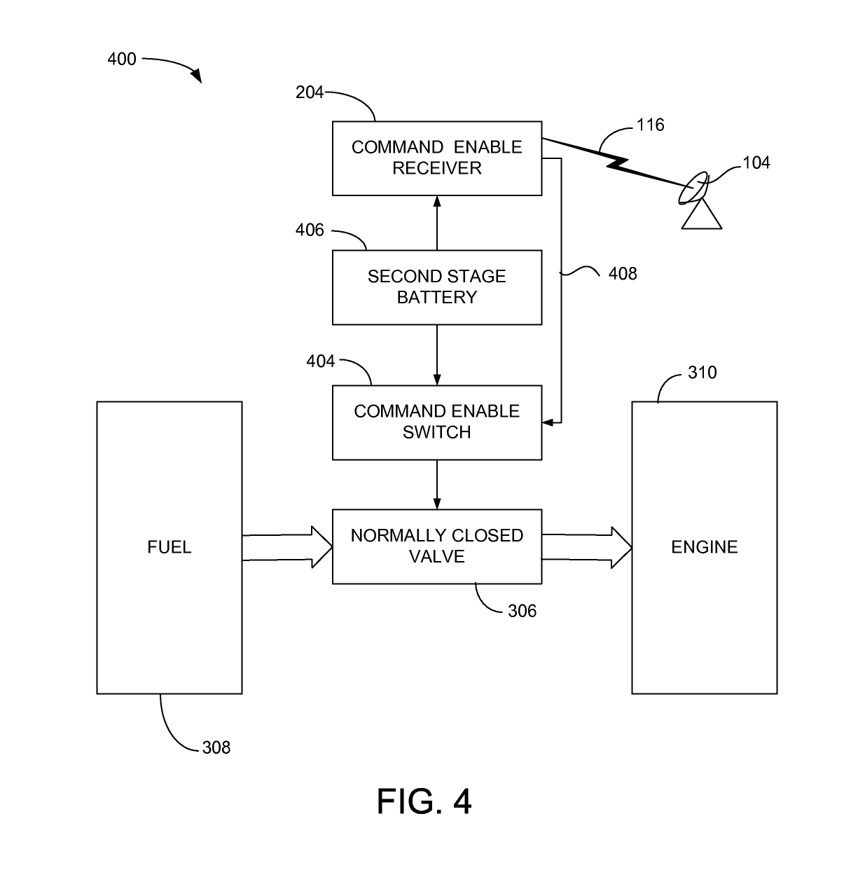

FIG. 4 is a block diagram illustrating a second exemplary embodiment of the fail-safe command destruct system 400 of FIG. 1A for a liquid-fueled upper stage, according to a preferred embodiment of the present invention. The command enable system includes the command enable receiver 204, the upper stage battery (or equivalent power supply) 406 and the command enable switch 404. The command enable receiver 204 (hereinafter “receiver 204”), functions to receive a command enable signal via link 116 to responsively generate a signal 408 to remove ignition inhibits (illustrated as normally closed valve 306) from the upper stage 114. Power conducted by the closed command enable switch 404 preferably comes from the same battery 406 as supplies the CER 204 (as shown) or, in other embodiments, may come from an independent source. In either case, failure of the CER 204 or failure to receive the command enable signal prevents ignition of the second stage 114.

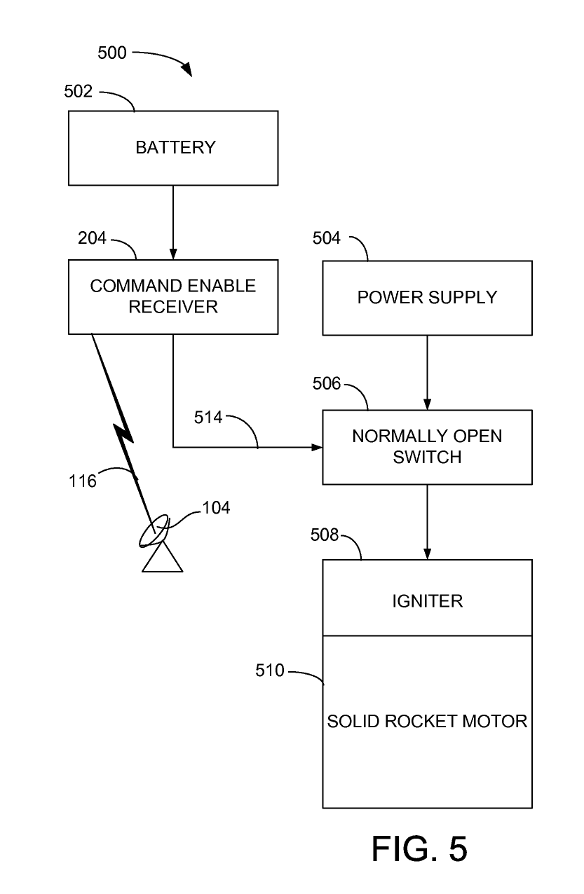

FIG. 5 is a block diagram illustrating another exemplary embodiment of the fail-safe command destruct system 500 for a solid-fueled stage that is deemed not to require an FTS 202, according to a preferred embodiment of the present invention. In this embodiment, an inhibit switch 506 is coupled between the power supply 504 and the igniter 508 of the solid rocket motor 510. Switch 506 is closed by a signal 514 from the command enable receiver 204 on a lower stage. Solid rocket motor 510 may be an upper stage or a strap-on that is sequenced to fire after launch. Command enable receiver 204 on a lower stage receives a command enable signal via link 116 from ground station 104, or elsewhere outside of the rocket, and generates signal 514 to close switch 506 responsive to the command enable signal. Thus, absent a command enable signal via link 116, the upper stage igniter 508 cannot ignite the solid rocket motor 510. The ignition inhibits are for upper stages that are not deemed to need an FTS 202 due to having ignition scheduled to occur past a predetermined safety point in the trajectory 106. Battery 502 supplies power to the command enable receiver 204 on a lower stage. In a particular embodiment, the battery for the CER 204 may be the power supply 504.

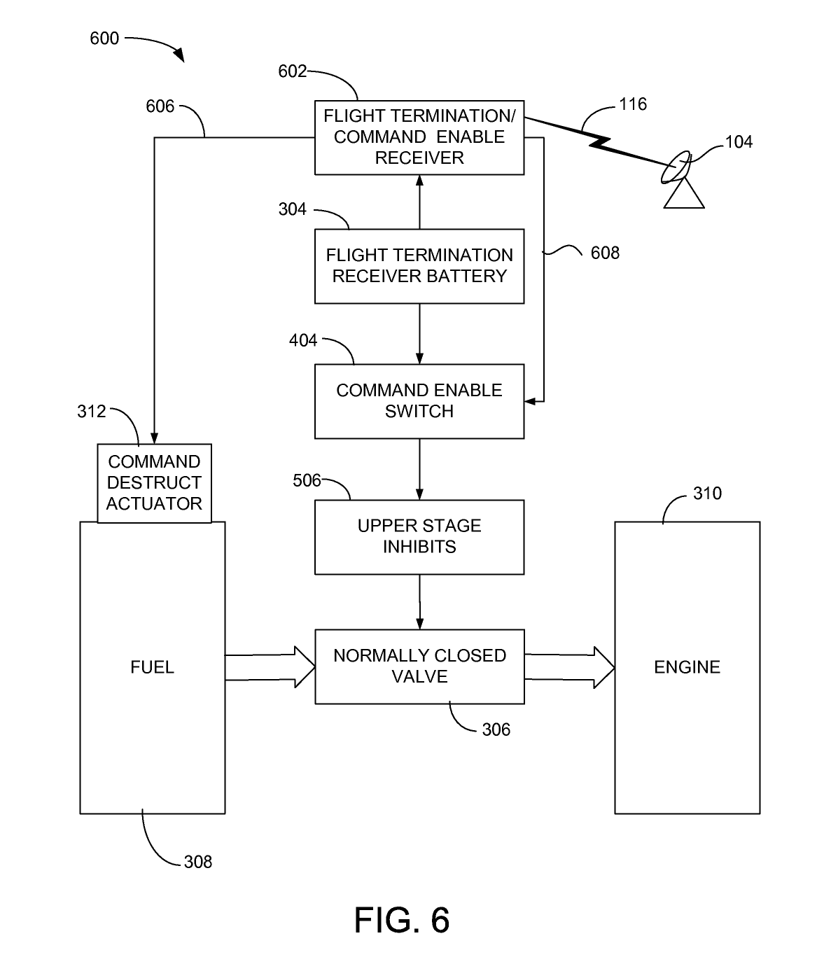

FIG. 6 is a block diagram illustrating a third exemplary embodiment of the fail-safe command destruct system 600 of FIG. 1A for a liquid-fueled stage, according to a preferred embodiment of the present invention. Fail-safe command destruct system 600 is a hybrid system. The flight termination receiver 302 has been modified into combined flight termination receiver and command enable receiver 602 (hereinafter “receiver 602”). Receiver 602 functions as a flight termination receiver 302 to receive a flight termination command via link 116 from ground station 104 and responsively generate a destruct signal 606 to command destruct actuator 312 to destroy the first stage 112 (illustrated as blowing up the fuel tank 308, one of various methods known in the art). Receiver 602 also functions as a command enable receiver 204 (see FIG. 4) to receive a command enable signal via link 116 to responsively generate a signal 608 to remove upper stage inhibits 506 such as normally closed valve 306.

Those of skill in the art, enlightened by the present disclosure, will be aware of obvious variations of the described embodiments, all of which are within the scope of the claims below.

1. A fail-safe command destruct system for a rocket, the system comprising:
a. a flight termination system; and
b. a command enable system.

2. The system of claim 1, wherein said command enable system comprises:
a. a wireless command enable receiver operable to receive a signal from a source external to said rocket;
b. an ignition inhibitor operable to inhibit ignition of a second or higher stage rocket engine of a multi-stage rocket; and
c. a command enable switch operable, responsive to a signal from said command enable receiver, to change the state of said ignition inhibitor.

3. The system of claim 2, a power source operable as the sole source of power to said command enable switch, and command enable receiver, and said ignition inhibitor.

4. The system of claim 2, wherein said ignition inhibitor comprises a normally closed fluidic valve, requiring application of power to remain open.

5. The system of claim 4, wherein said normally closed fluidic valve comprises a fuel valve.

6. The system of claim 4, wherein said normally closed fluidic valve comprises an oxidizer valve.

7. The system of claim 2, wherein said ignition inhibitor comprises a normally open electrical switch in an ignition circuit.

8. The system of claim 1, wherein said flight termination system comprises:
a. a flight termination receiver powered from a first stage power source and operable to receive a command destruct signal from outside said rocket;
b. a command destruct actuator responsive to a signal from said flight termination receiver to destroy or terminate the flight of said rocket;
c. a flight inhibiter requiring a constant source of power to permit flight; and
d. said first stage power source operable as the sole source of power to both the flight termination receiver and the flight inhibiter.

9. The system of claim 1, wherein said flight termination system is at least partially collocated with said command enable system.

10. A fail-safe command destruct system for a rocket, the system comprising:
a. a flight termination system comprising:
i. a flight termination receiver powered from a first stage power source and operable to receive a command destruct signal from outside or within said rocket;
ii. a command destruct actuator responsive to a signal from said flight termination receiver to destroy or terminate the flight of said rocket;
iii. a flight inhibiter requiring a constant source of power to permit flight; and
iv. said first stage power source operable as the sole source of power to both the flight termination receiver and the flight inhibiter; and
b. a command enable system.

11. The system of claim 11, wherein said flight termination system is at least partially collocated with said command enable system.

12. The system of claim 11, wherein said command enable system comprises:
a. a wireless command enable receiver operable to receive a signal from a source external to said rocket;
b. an ignition inhibitor operable to inhibit ignition of a second or higher stage rocket engine of a multi-stage rocket; and
c. a command enable switch operable, responsive to a signal from said command enable receiver, to change the state of said ignition inhibitor.

13. The system of claim 11, a power source operable as the sole source of power to said command enable switch, said command enable receiver, and said ignition inhibitor.

14. The system of claim 13, wherein said ignition inhibitor comprises one of:
a. a normally closed fluidic valve, requiring application of power to remain open and wherein said normally closed fluidic valve comprises at least one of a fuel valve and an oxidizer valve; and
b. a normally open electrical switch in an ignition circuit, requiring application of power to remain closed.

15. A fail-safe command destruct system for a rocket, the system comprising:
a. a flight termination system; and
b. a command enable system comprising:
i. a wireless command enable receiver operable to receive a signal from a source external to said rocket;
ii. an ignition inhibitor operable to inhibit ignition of a second or higher stage rocket engine of a multi-stage rocket;
iii. a command enable switch operable, responsive to a signal from said command enable receiver, to change the state of said ignition inhibitor; and
iv. a power source operable as the sole source of power to said command enable switch, said command enable receiver, and said ignition inhibitor.

16. The system of claim 15, wherein said ignition inhibitor comprises one of:
a. a normally closed fluidic valve, requiring application of power to remain open and wherein said normally closed fluidic valve comprises at least one of a fuel valve and an oxidizer valve; and
b. a normally open electrical switch in an ignition circuit, requiring application of power to remain closed.

17. The system of claim 15, wherein said flight termination system comprises:
a. a flight termination receiver powered from a first stage power source and operable to receive a command destruct signal from outside or within said rocket;
b. a command destruct actuator responsive to a signal from said flight termination receiver to destroy said rocket;
c. a flight inhibiter requiring a constant source of power to permit flight; and
d. said first stage power source operable as the sole source of power to both the flight termination receiver and the flight inhibiter.

18. The system of claim 15, wherein said flight termination system is at least partially collocated with said command enable system.

19. A fail-safe command destruct system for a rocket comprising a common battery configured to supply power to a flight termination receiver and a flight termination actuator, wherein said flight termination actuator is operable to terminate flight on the occurrence of one of:
a. battery failure; and
b. receipt of a destruct command in the command destruct receiver.

20. A fail-safe command destruct system for a rocket comprising an upper stage of a multistage rocket that is non-propulsive until an enabling command is received from outside said rocket.
